(19) United States
(12) Patent Application Publication
(10) Pub. No.: US 2003/0101152 A1
(43) Pub. Date: May 29, 2003

(54) Automated generation of intelligent systems into procedural languages

(76) Inventor: Richard C. Hicks, Jupiter, FL (US)

Correspondence Address: GREENBERG-TRAURIG, 1750 TYSONS BOULEVARD, 12TH FLOOR, MCLEAN, VA, 22102, US

(21) Appl. No.: 10/231,474

(22) Filed: Aug. 30, 2002

Related U.S. Application Data
(60) Provisional application No. 60/315,709, filed on Aug. 30, 2001.

(51) Int. Cl. G06N 5/00; G06F 17/00

(52) U.S. Cl. 706/45

(57) ABSTRACT

An expert system and methods of use that replaces the inference engine by generating code blending the rules in the knowledge base and the activities of the inference engine is described. This code may be generated into any procedural language (such as but not limited to C++ and Java). The combination of the elimination of the inference engine and code generation into a procedural language enable the creation of complied expert systems to replace the prior art of interpreted inference expert systems. The execution speed of compiled languages is substantially faster (at least 100×) than interpreted implementations, allowing (among many other things) more or larger intelligent applications to be executed.

### RELATED APPLICATION

The present application is related to and claims priority from Provisional U.S. Patent Application Serial No. 60/315,703, filed Aug. 30, 2001, the contents and teachings of which are incorporated herein in their entirety.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of the automated generation of computer code for intelligent application programs, such as but not limited to expert systems.

### BACKGROUND OF THE INVENTION

Intelligent systems are those systems that use complex logic to solve problems. In the following description expert systems are used as an example of intelligent systems.

Expert systems are a well-known and widely implemented technology that stores and replicates the sometimes highly complex problem solving strategies of a human expert in computerized form. For an overview of the field, see Winston, P. Artificial Intelligence, Addison-Wesley, Reading, Mass. 1984, the teachings of which are herein incorporated by reference in their entirety. A user may use an expert system by answering questions posed by the expert system. The expert system will respond with the same answer that the expert would give for the facts entered by the user. These systems are used for a wide variety of tasks like medical diagnosis, computer diagnostics, and credit authorization. They may even be developed for specific needs, such as the real-time systems described in U.S. Pat. No. 6,144,953, to Sorrells et al. dated Nov. 7, 2000, the teachings of which are herein incorporated by reference in their entirety.

Expert systems implementations are characterized by the use of an inference engine, which determines run-time execution flow. An expert system will also contain a user interface, a knowledge acquisition system, and a knowledge base containing the expert's strategies, usually expressed in IF/THEN rules. The inference engine examines the state of the consultation and the knowledge base to determine the next step to take, such as to seek an input or to test a rule. These activities are performed at run-time (i.e. during a consultation) and operate in an interpreted manner.

The prior art expert system development and delivery environment generally consists of five components, as illustrated in FIG. 1.

Knowledge Acquisition (KA) system 100 is used to create Knowledge Base (KB) 110. KA system 100 may use a wide variety of KB creation techniques, such as dedicated Integrated Development Environment (IDE), computerized techniques such as but not limited to induction, or it may be as simple as a text editor.

Knowledge Base 110 consists of necessary control instructions and expert knowledge, usually coded in a form of IF/THEN rules, necessary to solve a problem or set of problems. When an IF/THEN rule is tested, the values of the known facts are compared with the values in the IF portion of the rule. If all values match, the actions in the THEN portion of the rule, such as assigning a value that enables the testing of other rule clusters, are performed. Knowledge Base 110 may be arranged into rule clusters, each using a similar set of conditions to meet conclusions. There may be many levels of rule clusters, resulting in an inference hierarchy of rules with the goal at the top and the related clusters below. The rules are related, as conditions in one rule cluster often appear as conclusions in other rule clusters. Knowledge Base 110 must be in a form appropriate to the implementation platform (including the inference engine) and must meet many verification criteria to ensure accuracy.

Inference Engine 120 controls execution of an expert system. Inference Engine 120 uses a variety of inference strategies (such as but not limited to breadth first search, depth first search, forward chaining, backward chaining, and hybrid chaining) to exercise such control. Depending on the state of a given consultation, Inference Engine 120 can determine the sequence of needed inputs and rule testing to solve a given problem. Inference Engine 120 is typically implemented separate from the expert system and is called at run time. A flow chart of traditional prior art Inference Engine 120 implementations is illustrated in FIG. 2.

As FIG. 2 illustrates, Input/Output system 220 gathers facts, such as but not limited to user inputs, sensor inputs, or database retrievals, for Inference Engine 210 (similar to Inference Engine 120 of FIG. 1) and communicates with users. Input/Output system 220 typically asks users to input values and displays solutions.

Explanation Facility 230 (also Explanation Facility 130 of FIG. 1) explains to users how the expert system reached a value or solution. Normally, this consists of listing fired rules, the facts that caused the rules to be fired, the fact source, and an explanation or solution coded by a developer or expert.

Referring again to FIG. 1, Inference Engine 120 has four major tasks. Step one is to determine which rule in a given rule base, or set of rules, should be tested based on the current conclusion being sought. Step two is to determine if additional information, such as condition values, is needed to test the current rule and to obtain values for these conditions. Step three sends the condition values and the rule to a solver, which determines the truth or falsity of the rule. If the rule is true given the condition values, then the actions coded into the THEN part of the rule are taken (the rule “fires”), which usually consists of adding a new fact to memory. The fourth step is to determine if the goal of the consultation has been met. If not, the inference engine returns to step 1. If the goal has been met, the consultation is complete.

The chaining strategy employed by Inference Engine 120 in traditional expert systems is the initial determinant in selecting the most desirable rule to test. Chaining strategies include forward chaining, backward chaining, hill-climbing, and “best first”, among others. The accuracy of a consultation is not affected by chaining strategy choice, but computational efficiency is.

Backward chaining systems are goal driven. In such systems, Knowledge Base 110 can propose a solution (usually starting with the first rule in the rule cluster containing the goal) and Inference Engine 120 can finds facts that prove or disprove the solution(s) until a solution is found that fits the facts. These systems generally look at a rule base from the top cluster down.

Forward chaining systems take existing facts and apply them to rule clusters from the bottom up, adding new facts as rules fire until a solution is reached. Forward chaining systems that are not supplied every fact are often implemented as hybrid systems, as they backward chain to get values when necessary.

When an appropriate rule cluster is selected, a search strategy for that rule cluster must be determined. One important determinant is the cardinality of the conclusion. If the conclusion is “pure” multi-valued (i.e. all possible conclusions are returned), all inputs are required and all rules must be tested, and rule ordering strategies have no impact. Several other strategies may used to determine the “best” solution for a conclusion, including but limited to rule specificity and confidence factors. It may also be desirable to return all conclusions that meet other criteria. If the conclusion is single-valued, the inference engine starts with the first rule, gathering the necessary inputs and testing rules, and stops testing rules and gathering inputs as soon as one rule fires. Such situations are typically referred to as first rule satisfied (FRS) implementations.

In any case but “pure” multi-valued conclusions, rule ordering is significant; for example, if the conclusion with the highest confidence factor is the most desirable conclusion, then the rules should be ordered by confidence factors in descending order. In the prior art, FRS rule clusters are typically ordered with the most specific rules first.

When Inference Engine 120 determines which rule cluster to test, it will search through a rule cluster to find rules that fits the current facts. Two basic search strategies include breadth-first searches and depth-first searches. In breadth-first searches, conditions in a rule are input and the rules are tested sequentially until a rule fires. In depth-first searches, each condition is input and all rules are tested, inputting additional inputs until a rule fires. These characteristics indicate that the most desirable rules should be ordered first in a depth-first inference engine, while the most desirable conditions should be ordered first in a depth-first inference engine. These problems will be described herein from a breadth-first perspective, although one skilled in the art can easily apply the concepts to depth-first approaches.

When the most desirable rule has been determined, the facts needed to test the rule are compared to the known facts and any necessary values are obtained. Necessary values may be obtained from a wide variety of sources, such as but not limited to user input, database retrieval, and sensor inputs. Inference Engine 120 uses a solver component to test the rule by comparing the values to conditions in the rule. If the values and conditions match, the rule “fires” and the conclusion (THEN) component of the rule is executed. The THEN component will usually add or change the values of a fact, although it may also take other actions such as but not limited to displaying an image, sending an email, performing a database transaction, or displaying a message to an operator or another computer.

After each rule fires, Inference Engine 120 will determine if the goal of the consultation has been met. If so, the consultation is complete and the program ends. If the goal of the consultation has not been met, Inference Engine 120 reevaluates the state of the consultation and determines the next step to take. This cycle continues until the goal is met or the system determines that a solution cannot be reached from the available facts.

The prior art poses many shortcomings, such as but not limited to computational efficiency, memory and machine usage, cost for purchase and support of additional software, and implementation limitations (does inference engine X support database Y?), all of which make implementing and deploying expert systems difficult and cost prohibitive, and frequently result in expert systems that do not meet users' expectations.

### SUMMARY OF THE INVENTION

Accordingly, the present invention is directed to automated generation of intelligent systems into procedural languages that substantially obviates one or more of the problems due to limitations and disadvantages of the related art. Briefly stated, the invention is an IDE (Integrated Development Environment) that allows an individual with typical computer skills to develop, test, and generate code for intelligent systems, such as expert systems. The present invention may be biased to achieve a “best” strategy for a wide range of “most desirable implementation characteristics,” such as but not limited to minimization of user inputs, lowest consultation cost, or highest computational efficiency.

An object of the present invention is to automatically test a user's inputs to ensure their legality in a host language, such as by testing reserved words and syntax, thereby eliminating a potential error source.

A further object of the present invention is to automatically test user structures for criteria such as cycles, thereby eliminating an error source.

An additional object of the present invention is to increase system accuracy and efficiency by enforcing verification criteria for at least five types of rules, allowing for simplification, rule ordering, and “best answer” strategies for a rule cluster.

Another object of the present invention is to further eliminate a potential error source by automatically testing rules as they are entered by a user, eliminating subsumptions and conflictions when appropriate.

Still another object of the present invention is to algorithmically simplify rules by eliminating unnecessary conditions and combining appropriate ranges in numeric values and dates, thereby increasing run-time efficiency.

Yet another object of the present invention is to algorithmically order each rule cluster by solution strategy, which increases both speed and/or efficiency.

Additional features and advantages of the invention will be set forth in the description which follows, and in part will be apparent from the description, or may be learned by practice of the invention. The objectives and other advantages of the invention can be realized and attained by the structure particularly pointed out in the written description and claims hereof as well as the appended drawings.

The current art of intelligent systems, such as expert systems, is implemented with a rule base and an inference engine. The rule base contains the problem solving strategy for solving the problem, where the inference engine is a computer program that is designed to work with the knowledge base. The inference engine loads the rule base at run-time and then uses a conflict-resolution strategy to determine which rules to test, and therefore what inputs to obtain.

The present invention eliminates the need for an external inference engine by generating code that blends knowledge base rules and inference engine activities. This code may be generated into any procedural language (such as but not limited to C++ and Java). By eliminating the inference engine and generating code into a procedural language, complied expert systems can be created which replace prior art interpreted inference expert systems. The execution speed of compiled languages is substantially faster (at least 100×) than interpreted implementations, allowing (among many other things) more or larger intelligent applications to be executed using existing systems.

The present invention removes the need for an inference engine by performing most of the inference engine tasks, such as conflict resolution, during development in an Integrated Development Environment (IDE). The resulting solution can be transposed into any procedural language and implemented without an inference engine. The use of procedural languages allows compiling of the solution, which dramatically increases execution speed and lowers machine resource usage.

However, speed is nothing without accuracy. To facilitate building an intelligent system, the IDE of the present invention supports five classes of rules, which are preferably classified by the verification criteria met by each rule class. The IDE constrains each rule cluster for the appropriate criteria. Each class uses a specific refinement strategy, rule-ordering strategy, and solution strategy dictated by the verification criteria met by each rule class, allowing each rule class to be biased for speed or accuracy.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flow diagram of a prior art expert system.

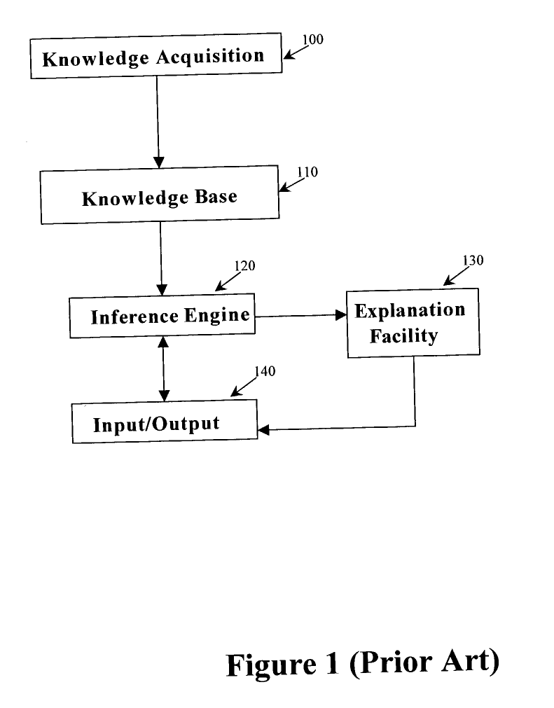

FIG. 2 is a flow diagram of a prior art expert system implementation wherein the inference engine is separate from the main application program.

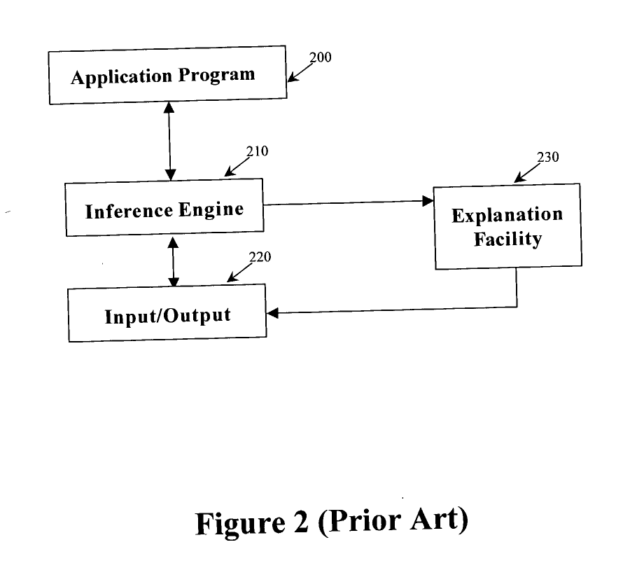

FIG. 3 is a flow diagram of an expert system implementation according to the present invention wherein code generated by the current invention is embedded as a component of the application program.

FIG. 4 is a flow diagram of steps taken in building a system according to a preferred embodiment of the present invention.

FIG. 5 is a screen capture illustrating a sample Conditions Editor interface used to create condition definitions.

FIG. 6 is a screen capture illustrating a sample Actions Editor interface, which is used to create action definitions.

FIG. 7 is a screen capture illustrating a sample Rule Cluster Editor interface, in which defined conditions and actions can be linked to create rule clusters.

FIG. 8 is a screen capture illustrating a sample Rule Browser interface.

FIG. 8a is a screen capture illustrating a sample Rule Browser interface, which has been expanded to facilitate rule creation.

FIG. 9 is a screen capture illustrating a sample New Project creator interface.

### DETAILED DESCRIPTION OF THE PREFERRED EMBODIMENT

Reference will now be made in detail to the preferred embodiments of the present invention, examples of which are illustrated in the accompanying drawings.

The present invention generates code that combines the actions of an Inference Engine and the knowledge of an expert, which is expressed in procedural rules in an IF/THEN format, thereby eliminating the need for an Inference Engine. Essentially, the present invention is a code optimization and generation component for an intelligent systems Integrated Development Environment (IDE). The IDE acquires knowledge from an expert, verifies it, refines it, optimizes it, and generates code, including a rule base. After a rule base has been created in the IDE, the present invention analyzes it to determine the “best” path to a solution and generates code in the desired development language.

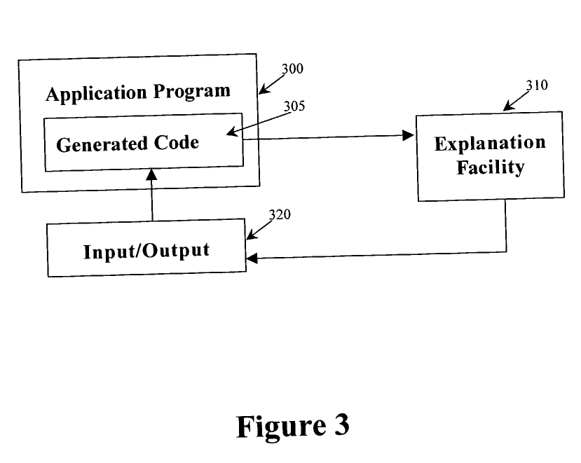

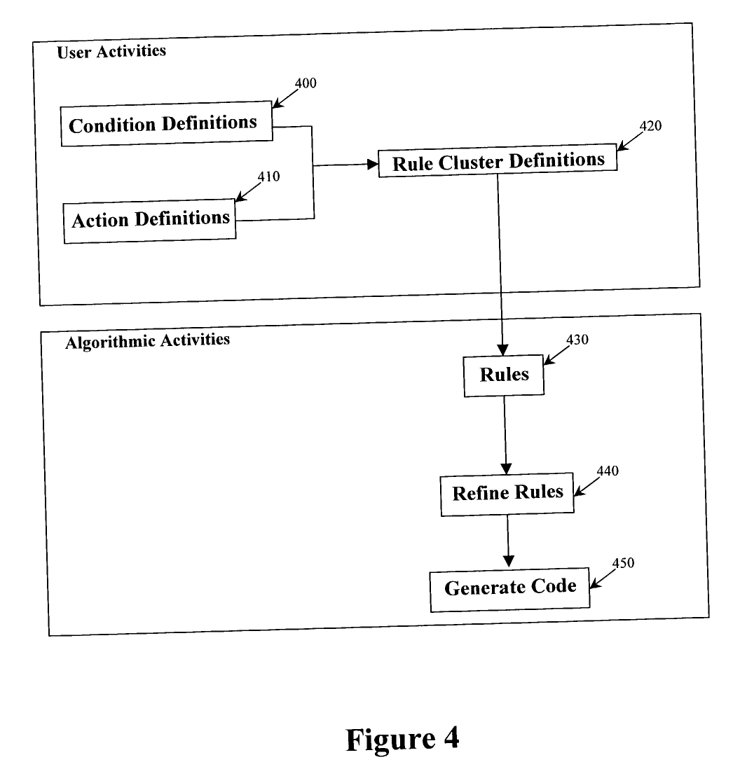

An expert systems implementation flow chart according to a preferred embodiment of the present invention is illustrated in FIG. 3. A chart showing the flow of activities in the present invention is illustrated in FIG. 4.

Before using the IDE, a user should define the scope of the proposed system. This is typically accomplished by determining the output of the project, which will become the goal (top) rule cluster in a knowledge map. Next, the user determines what conditions will be needed to satisfy the goal. Finally, conditions and necessary actions are defined by determining their name, legal values, data type, and source. Each condition may get its value from a source (user, sensor, database, etc.) or from another set of rules. This completes the definition of a rule cluster.

The output of this phase is a knowledge map of the proposed system, including the goal of the system at the top of the inference hierarchy and the rule clusters that provide values for conditions below them. Such a knowledge map is useful in defining the overall structure of the system. During the above-described process, the knowledge map is extended whenever a condition variable gets its value from other rules. This is accomplished by the creation of a rule cluster containing the variable as an action. When all conditions, actions, and rule clusters have been defined, the user is ready to begin using the IDE.

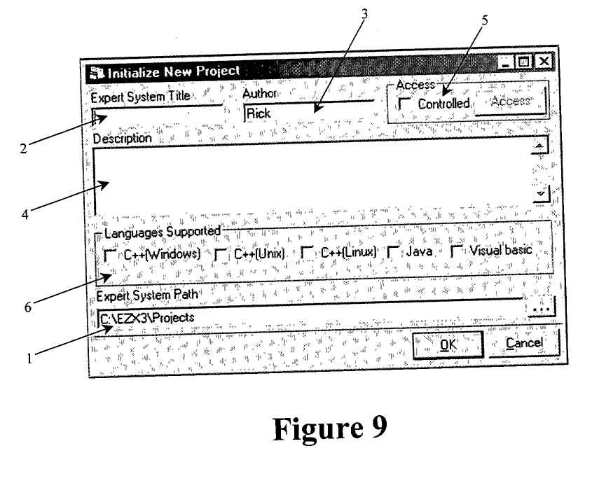

The first entry into the IDE is the definition of the goal rule cluster. The IDE will then lead the user through the process of creating the project. As FIG. 9 illustrates, a preferred embodiment of the IDE begins system definition by obtaining the name of the system, languages supported, and other initialization data. The location of files associated with the system is dictated by the entries in Path 1 and Project Directory 1. The system's title is entered in Expert System Title 2, the author is entered in Author 3, access restrictions are entered using Access 5, and the computer programming languages supported by this project are entered in Languages supported 6. If desired, a description may also be entered in Description box 4.

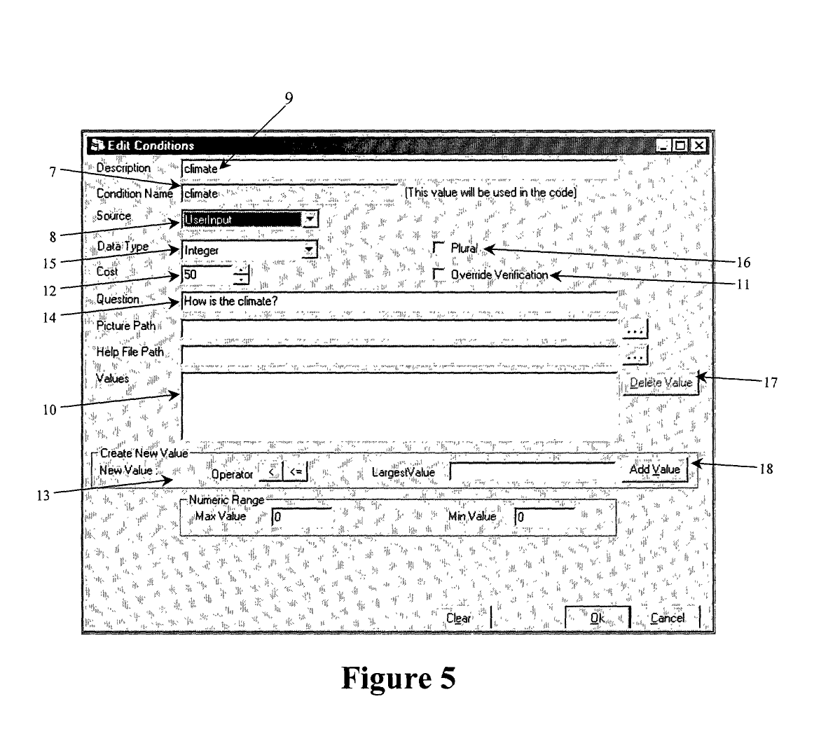

As FIG. 4 illustrates, the system definition process begins in earnest with the creation of Conditions 400 and Action Definitions 410. A sample Conditions Editor is illustrated in FIG. 5. Each condition definition preferably contains the name 7, description 9, source 5, data type 15, cost 12, cardinality (single or multi-valued) 16, and values 10 associated with a condition. The description is used to reference the condition and does not require validation. Name 7 is used in the generated code, so it must be verified for compatibility in the supported languages; that is, special characters, key words, and the like must not appear in the name. Values 10 must also be legal in the supported language (or an appropriate workaround must be adopted in the code generator), distinct, and ranges such as dates or numeric values must be complete. Data types 15 are used to generate output code and assure that legal values are assigned, such as allowing only True and False values for a Boolean condition. Cost 12 is used in ordering deterministic rule clusters. Source 5 may be an input source, such as but not limited to user input, database retrievals, sensors, or even other rules. Conditions that receive one or more values from other rules automatically generate a new rule cluster containing this condition as an action.

The Conditions Editor of FIG. 5 also allows a user to identify data necessary to implement each condition. For user inputs, it elicits a question 14 to be asked at run-time. Database and sensor components are preferably defined using a separate screen, and these definitions are used in the Condition Editor.

The Conditions Editor of FIG. 5 is also used to create a set of values used by the condition. The Create New Value box 13 is used by the user to enter potential values. When the Add Value Button 18 is pushed, the potential value is tested for legality according to its data type. The user may override these tests by checking the Override Verification button 11. Previously defined acceptable values are stored in the Value box 10. They may be deleted from the Value box by selecting the value and pressing the Delete Value button 17.

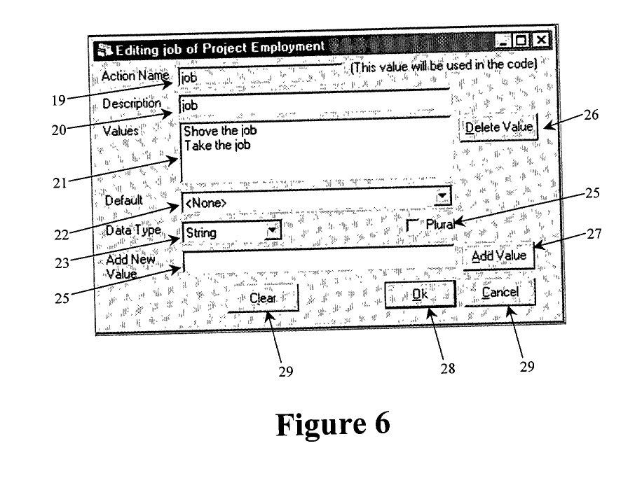

Referring again to FIG. 4, system definition according to a preferred embodiment of the present invention also requires an Action Definition step (Block 410). In a preferred embodiment, actions are defined using an Actions Editor similar to that illustrated in FIG. 6. Each action definition should contain the action name 19, description 20, data type 23, cardinality (single or multi-valued) 24, and values 21. As with the Conditions Editor of FIG. 5, a preferred Action Editor will verify name 19 and values 21 for legality (syntax, reserved words, etc.) in the selected language(s), complete numeric and date ranges, and the like. It should be noted that any condition that obtains a value from other rules will preferably also be defined as an action, and that these definitions must remain consistent throughout the life of the project. The Add New Value box 25 is used by the developer to create new action values. When the Add Value button 27 is pressed, the new action value is tested for legality in the host language and data type constraints. If the value is acceptable, it is placed in Values box 21, where it can be removed by selecting the desired value and pressing the Delete Value button 25. Common interface elements such as Cancel Button 29, OK Button 28, and Clear button 29 are also preferably provided for all screens.

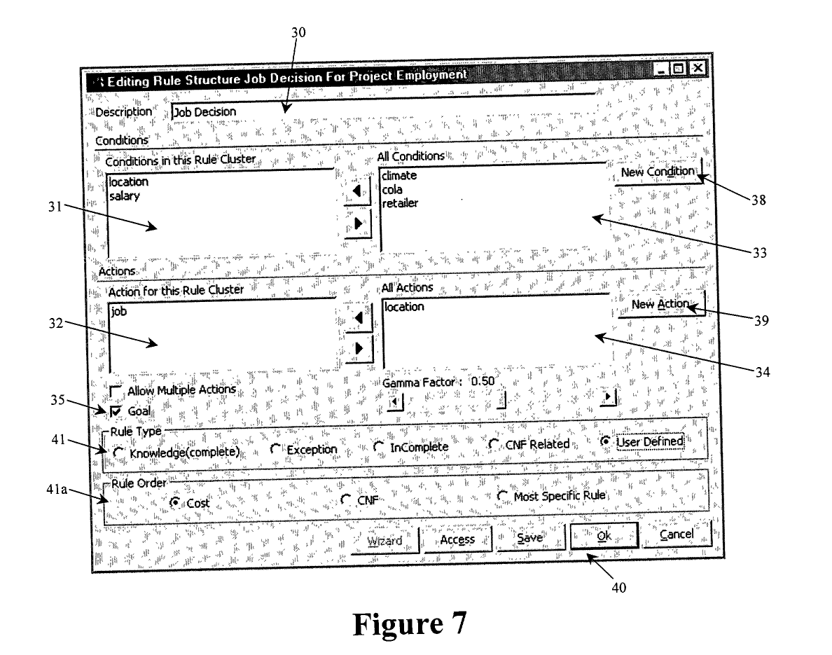

Referring again to FIG. 4, once conditions (Block 400) and actions (Block 410) are appropriately defined, the IDE then allows a user to define rule clusters (Block 420), preferably using a Rule Structure Editor. A preferred Rule Structure Editor interface is shown in FIG. 7. Each rule cluster is defined as containing a well-formed set of conditions 31 and actions 32. The conditions and actions used in the current rule are chosen from lists of conditions 33 and actions 34 that have been defined, using the Add and Delete buttons 36 in the middle of the screen. Additional conditions can be defined by pressing New Condition button 38, and new actions can be created by pressing the New Action button 39. The level of access to the rule cluster for individual users can be controlled by pressing Access button 40. A goal rule cluster, as defined in Goal 35, is a top-level rule cluster, and it is preferred that only one goal rule cluster exist in a system.

Rule Type 41 is also defined in this screen. The Rule Types preferably supported by the present invention include:

Rule Type 1: Deterministic knowledge. This knowledge is preferably verified for completeness and consistency, and there is no uncertainty about the validity of the knowledge. These rules should be simplified by one or more action values during compilation, as there are no untrue rules and the knowledge is complete. The rules are preferably ordered by lowest cost, then highest confidence, then most general. A default, which may consist of, but is not limited to, a default value, eliciting a response from a user, ignoring and continuing, or aborting the consultation is not required with type 1 rules, but is preferably required for all other rule types.

Rule Type 2: Exceptions. This knowledge contains exceptions, meaning that uncertainty, confliction, subsumption, and incompleteness may be present. These rules should not be simplified during compilation. If a user requests simplification, confidence factors are also evaluated to determine rule equalities. The rules are preferably ordered by most specific, then highest confidence, then lowest cost.

Rule Type 3: Incomplete knowledge. This knowledge does not contain all possible condition value combinations, but the knowledge is consistent and no uncertainty exists. Such rules should be simplified by action values with some caution, as counterexamples may exist that are not reflected in the system. Such rules should preferably be ordered by lowest cost, then highest confidence, then most general.

Rule Type 4: Belief-related strategies. This knowledge is uncertain, and the most desirable rules are those with the highest belief in the rules, which is expressed in terms of Confidence Factors (CNF). Conflictions are expected, especially when using a traditional definition of confliction, such as one that does not consider the confidence factor. Subsumptions and incompleteness may also exist. Simplification of these rules is done with considerable caution. If a user requests simplification, confidence factors are also evaluated to determine rule equalities. These rules are preferably ordered by highest confidence, then most specific, then lowest cost.

Rule Type 5: Uncontrolled rules. These rules may exhibit violations of any verification criteria. They are created, verified, and ordered by a user. Caution should be used when simplifying these rules, and simplification is preferably done only when requested by a user. If a user requests simplification, confidence factors are also evaluated to determine rule equalities. A user may choose to order the rules by cost, confidence, or specificity.

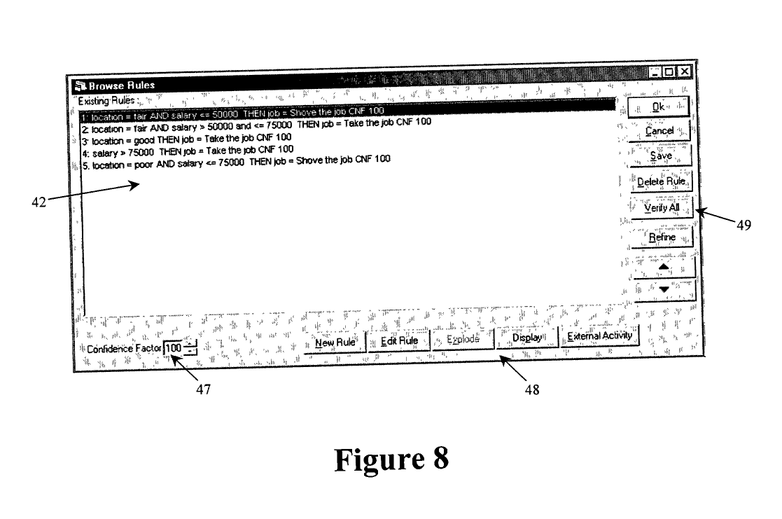

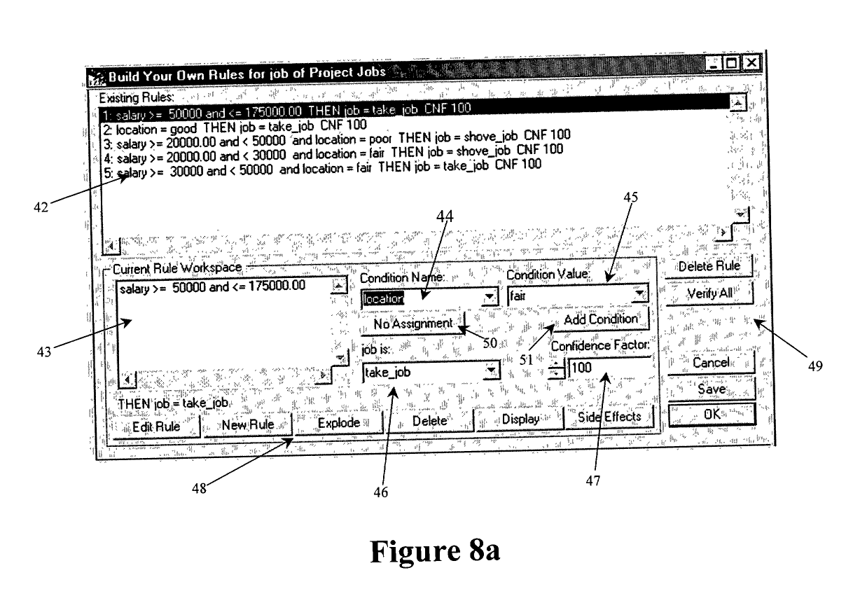

A rule editor, including the preferred Rule Browser interface illustrated in FIG. 8 and the preferred Rule Editor interface illustrated in FIG. 8a, can be used to create and manage rules in the present invention. Similar features in FIG. 8 and FIG. 8a are similarly labeled. The Rule Structure, Conditions, and Actions definitions are used to create and constrain the rules. The rules are verified for the criteria applicable to the defined rule type as described above.

Existing rules are shown in Existing Rules box 42. New rules are created in Current Rules Workspace region of FIG. 8a, where the current definition is shown 44. The user may select conditions 44 and values for that condition 45 and use the Add Condition button 51 to add this condition to the rule definition in the Current Rule Workspace 43. An action value can be assigned in the Action box 45. A CNF, used to express belief in the rule, may be entered in the Confidence Factor box 47. The Edit Rule Button will read Add Rule when the rule is being created or edited. When this button is pushed, the rule is tested for consistency with the existing rules. If the rule is acceptable, it is added to Existing Rules 42.

The bottom row of interface buttons 48 is used to begin editing a rule, start creating a new rule, exploding the rule to remove any simplifications that have taken place, delete the selected condition from the Current Rule Workspace, and to add generic Display statements (messages that will be displayed in any language) as well as Side-effect operations that are language dependent. In addition, buttons 49 are provided to delete the selected rule and to perform verification on the Existing Rules.

Completed rule sets are simplified to derive a minimal set of rules which contain the truths in the original knowledge. Type 1 rule clusters may be simplified without any affect on accuracy. Type 2 rule clusters should not be simplified, as they contain exceptions. Type 3, 4, and 5 rule clusters should be simplified with caution, as these rule clusters may contain rules that are untrue by themselves but which are true in the context and ordering of the rule cluster. Simplification techniques supported by the present invention include the ID3 algorithm and the R3 algorithms. These algorithms are taught in Quinlan, J. R. “Simplifying Decision Trees”, Knowledge Acquisition for Knowledge-Based Systems, Gaines, B., and Boose, J., editors, Academic Press, 1988, and Hicks, Richard C. “Minimizing Maintenance Anomalies in Expert System Rule Bases,” Information and Management, Vol. 28, 1995, pp. 177-184, respectively, and the teachings thereof are incorporated herein by reference in their entirety.

The above-referenced simplification techniques allows knowledge to be simplified by using truth-preserving algorithms to derive a minimal solution set. By way of example, without intending to limit the present invention, one test set is the Chess end-game set, which has 648 rules with 7 clauses (condition tests) in each rule for a total of 4536 clauses. The ID3 algorithm reduces this to 335 clauses, where R3 reduces the rule base to 20 rules with 60 clauses. Each of the three rule sets (original, ID3, and R3) result in the same conclusions, but ID3 and R3 rule bases run much faster.

After rules are simplified, they are ordered. Each rule type uses a specific set of verification criteria which dictates rule ordering. Rule Type 2 is ordered by rule specificity, as exceptions are present. Rule Type 4 is ordered by developer CNF, as these are the rules with the strongest beliefs. Rule Type 5 is ordered by the user. These orderings are not affected by Rule Ordering by Computational Cost (ROCK), which is used to order only Type 1 and Type 3 rule clusters. ROCK is described in more detail below.

Rule Types 1 and 3 are deterministic, so they may be ordered for efficiency without affecting accuracy. To achieve the lowest cost performance, the current invention employees ROCK during development to derive an optimal sequencing strategy and Rule Ordering in Logical Layers (ROLL) at run-time to minimize the cost of the consultation. ROLL is described in more detail below.

Unlike much of the prior art, which determined search path only at run-time, ROCK may be performed during development, yielding a static input sequence, or at run-time to achieve a dynamic input sequence. Where the expert system inputs are static, such as a system that is passed no inputs or a specific set of inputs, a static sequence is superior in run-time computational performance. However, when the inputs are dynamic, then run-time ROCK may find a lower-cost sequence of inputs. The generation of code using static ROCK is described below, although implementation of a dynamic ROCK code generation system should be apparent to one skilled in the art.

Rule ordering preferably begins at the bottom of the inference hierarchy. The first step in optimizing a Type 1 or Type 3 rule cluster is typically to determine the most desirable path through the rule base that can solve the consultation. The most desirable path is determined by ordering the available paths through the rule base by the controlling characteristic, such as but not limited to number of inputs, cost of inputs, time to reach a solution, or highest confidence factor. The output of ROCK is an ordered set of inputs and an indication of when rules should be tested. The example below uses a number of inputs as controlling characteristics, with the number of rules tested used to break ties. An example rule base follows, and the generated output for this example is shown in the “Table of C Code Generated by IDE”.

Step 1—Before code is generated, the rule base is ordered using the ROCK technique, and the following steps are typically performed during ROCK. Beginning with the lowest rule cluster in the hierarchy and moving to the top rule cluster, each rule cluster is ordered so that the most desirable rules are on top (assuming breadth-first search; the extension to depth-first search orders conditions from left to right). Single-valued conclusions result in rule orderings such as but not limited to lowest cost, most specific, or minimal number of inputs. “Pure” multi-valued conclusions are not necessarily ordered, as all inputs are needed and all outputs are returned. Other multi-valued rule clusters are ordered by the desired characteristic, such as but not limited to confidence factors or the number of conditions in each rule. Rule ordering is also impacted by verification of the rule cluster. The present invention determines the verification state of the rule cluster and uses this information to order the rule cluster. For example, if the rule cluster is free from subsumptions and conflictions, FRS rule clusters may be ordered with the most general rules first, lowering the information needed to solve the consultation and usually yielding the lowest cost when compared to the prior art technique of most specific rules first. This has the impact of performing many conflict-resolution tasks during development.

Step 2—If facts may be known at the beginning of the consultation through programming practices such as but not limited to defaults or parameter passing, code is generated to perform procedural forward chaining. In the present invention, code is preferably generated to examine the entire rule base structure from the bottom up using a “best first” strategy to determine if known facts are present in any rule cluster. If so, generate a call to a function, and pass the known facts thereto, where the function called compares the known facts to those contained in the rules in the form of procedural IF statements. If all of the facts match all of the conditions in the rule, the THEN portion of the rule is performed. If the conclusion is single-valued, stop testing the rule cluster and return. If the conclusion is multi-valued, test all of the rules in the cluster and return. If rules fire, or are true, in any cluster, determine if the goal has been met. If so, the consultation is complete. (The preceding code is omitted from the “Table of C Code Generated by IDE” for brevity). If the rules do not fire in a cluster, the facts known at the beginning of the execution and any new facts obtained by rule firings are used in continuing the consultation. If enough facts are passed, the consultation may take place transparently.

The remaining steps, which describe the ROLL process, are performed as in a loop until all rules in the rule base have been coded.

Step 3—Using the first unused rule in each rule cluster, determine the next input that is needed by the current path. The next input is located in the highest rule cluster in the inference hierarchy that can reach a conclusion without requiring a value from another rule cluster, including the current rule cluster. Code is generated that begins a code block by checking to see if a value has been determined and obtaining the value for the desired input if necessary.

Step 4—When an input had been sequenced, determine one or more subsets of rules that can be fired by this input and any previously obtained inputs. These subsets are referred to as logical layers. Each rule will preferably belong to a single logical layer determined by the minimal set of inputs necessary to fire the rule. Code should be generated to perform the tests contained in the rules in the logical layer and perform the activities specified in the THEN portion of the rules.

Step 5—Code should be generated to determine if the current conclusion is satisfied. If so, the code effectively ends the code block for this conclusion, which emulates forward chaining. If the conclusion is not satisfied (the ELSE portion of the test that determines if the conclusion is satisfied), generate each possible solution to the unsatisfied conclusion as in Steps 1 through 4. This emulates backward chaining.

Step 6—After the code for each input, logical layer and outcome is generated, use the same technique to determine the next set of inputs until all inputs and rules are utilized. Inputs that have already been derived or will be available at run-time do not have a further cost and are therefore not included in the calculations. This information is retained in the IDE. Note that each rule is tested only once.

A small example of a simplified FRS rule base is presented below in conjunctive normal form. A preferred simplification technique result is the production of rules that do not require all of the inputs to reach a conclusion. Note that Job1, Job2, Job3, Location1, and Location2 require only a single input. (Note: this example is designed for ease of reading, where the actual implementation may take many different forms.)

Job Rule Cluster
Rule job1
IF salary >= 40000
THEN job = take_job
Rule job2
IF location = good
THEN job = take_job CNF 100;
Rule job3
IF location = poor

AND salary < 40000

THEN job = shove_job
Rule job4
IF location = fair

AND salary < 30000

THEN job = shove_job
Rule job5
IF location fair

AND salary >= 30000

THEN job = take_job
Location Rule Cluster
Rule location1
IF climate = good
THEN location = good
Rule location2
IF climate = poor
THEN location = poor
Rule location3
IF climate = fair

AND cola = low

THEN location = good
Rule location4
IF climate = fair

AND cola = medium

THEN location = fair
Rule location5
IF climate = fair

AND cola = high

THEN location = poor

In this Job Example of ROCK, Salary alone can fire a rule, Job1, which will solve the consultation. Climate can also fire a rule, Location1, which will allow other rules to fire, Job2 and Job3, which will solve the consultation. Assuming the desired characteristic for this implementation is speed, the combined execution speed for Salary is lower than that of Location as fewer tests are performed (1 rule for Salary vs. 2 if Climate is hot or 3 rules if Climate is cold, depending on ordering), so the first input in this sequence would be Salary.

The appropriate value for Salary can fire a rule by itself, so the input for Salary would be followed by an instruction to test the logical layer of rules, Job1, that can be satisfied by the inputs. Next it is determined when sufficient inputs exist to fire a new partition of the rule cluster. If Salary did not solve the consultation, the result would be to retrieve the next most desirable input, Climate and test Location1 and Location2. If Location is not satisfied, we get the value for COLA (Cost of Living) and test Location3, Location4, and Location5. At this point, all Location rules have been tested and a value must be assigned, as these rule clusters are verified for completeness. As all inputs are obtained, we test the remaining rules Job2 through Job5. All of the inputs are rules have been sequenced. Generate any necessary closing code, such as for the return of values and housekeeping to terminate the generated code.

ROLL uses the information in the IDE to generate code using the ROCK strategy. Code in the language C is contained in the Table of C Code Generated by IDE. The code flowchart, or pseudocode, is shown below.

Input - Salary
Test - Job1
If Job is not satisfied,

Input - Climate
Test - Location1 and Location2

If Location is not satisfied,

Input - Cola
Test - Location 3 through Location5.
Test - Job2 through Job5

In a traditional backward-chaining strategy, the Location rule cluster would be solved first, obtaining inputs for climate and Cola to determine Location and then obtaining Salary so that all the variables in the Job rule cluster are instantiated. It would then test all of the rules in the Job rule cluster. ROCK would begin with the Job rule cluster, as it contains the first input, Salary. After Salary has a value, the rule Job1 may fire. Therefore, we test the value for Salary with the rule Job1. If it passes, the consultation is complete. In this consultation, the Location rule cluster would not be solved. In many consultations, ROCK will minimize the number of inputs necessary to solve the consultation by solving a rule cluster with a minimal set of inputs and additionally by avoiding the solving of some rule clusters, effectively pruning the search space.

A Table of Sample C Code Generated by IDE is included below. This sample code is intended as an example of the type of code created by a preferred embodiment of the present invention, and should not be seen as limiting the present invention. By way of example, known fact forward chaining is omitted from the sample code below for brevity, but incorporation of a means for fact forward chaining should be apparent to one skilled in the art. It should also be apparent to one skilled in the art that alternative computer programming languages, as well as alternative functions, procedures, and architectures, can be substituted for the sample code provided below without departing from the spirit or the scope of the present invention.

```
///////////////////////////////////////////////////
// C Code for project App14 generated by EZ-Xpert Logic Factory //
// If desired, replace the Actions Box with Custom Actions Box code
  in C:\EZ-Xpert\App14\Appl4.ac //
// If desired, replace the Statements Box with Custom Statements Box
  code in C:\EZ-Xpert\App14\App14.sc //
// Project Data: //
// Project Title: Job Kill 8 //
// Project Name: App14 //
// File Location: C:\EZ-Xpert\App14 //
// Author: Tech Support //
// Description: //
// Long Name Test 2 //
// Project Last Modified: 12/26/00 //
// Code Generated: 02/18/01 //
// Start of Actions Block //
// Include standard libraries. //
#include <stdio.h>
#include <string.h>
// Declare global variables. //
char Job [8];
float Salary = 0.0f;
char Location [5];
char Climate [5];
char COLA [7];
// Input Function Prototypes //
void GetSalary (void);
void GetClimate (void);
void GetCOLA (void);
// The following line is in the Actions Block //
void main ( )
{
```

GetSalary ( );
{

/* Rule 1 for goal Job */
if (Salary >= 60000)
{

strcpy (Job, “TakeJob”);
printf (“\n\nThe value for Job is TakeJob\n”);
return;

}

}
GetClimate ( );
{

/* Rule 1 for goal Location */
if (strcmp (Climate, “Hot”) == 0)
{

strcpy (Location, “Good”);

}
/* Rule 2 for goal Location */
else if (strcmp (Climate, “Cold”) == 0)
{

strcpy (Location, “Poor”);

}

}
if ( ! (strcmp (Location, “Fair”) == 0) &&
(strcmp (Location, “Good”) == 0) && ! (strcmp (Location, “Poor”) == 0))
{

GetCOLA ( );
/* Rule 3 for goal Location */
if ((strcmp (Climate, “Mild”) == 0) &&
(strcmp (COLA, “Medium”) == 0) )
{

strcpy (Location, “Fair”)

}
/* Rule 4 for goal Location */
else if ((strcmp (Climate, “Mild”) == 0) &&
(strcmp (COLA, “Low”) == 0) )
{

strcpy (Location, “Good”);

}
/* Rule 5 for goal Location */
else if ((strcmp (Climate, “Mild”) == 0) &&
(strcmp (COLA, “High”) == 0) )
{

strcpy (Location, “Poor”);

}

{
if ( ! (strcmp (Job, “ShoveJob”) == 0) &&
! (strcmp (Job, “TakeJob”) == 0))
{

/* Rule 2 for goal Job */
if (strcmp (Location, “Good”) == 0)
{

strcpy (Job, “TakeJob”);
printf (“\n\nThe value for Job is TakeJob\n”);
return;

}

}
if ( ! (strcmp (Job, “ShoveJob”) == 0) &&
! (strcmp (Job, “TakeJob”) == 0))
{

/* Rule 3 for goal Job */
if ((strcmp (Location, “Poor”) == 0) && (Salary < 60000) )
{

strcpy (Job, “ShoveJob”);
printf (“\n\nThe value for Job is ShoveJob\n”);
return;

}
/* Rule 4 for goal Job */
else if ((strcmp (Location, “Fair”) == 0) && (Salary < 40000) )
{

strcpy (Job, “ShoveJob”);
printf (“\n\nThe value for Job is ShoveJob\n”);
return;

}
/* Rule 5 for goal Job */
else if ((strcmp (Location, “Fair”) == 0) && (Salary >= 40000
) && (Salary < 60000) )
{

strcpy (Job, “TakeJob”);
printf (“\n\nThe value for Job is TakeJob\n”);
return;

}

}

}
//////////////////////////////////////////////
// C Input Statements for project App14 generated by EZ-Xpert Logic

Factory //

| // Function for input of Salary // | |
|---|---|
| void GetSalary (void) | |
| { | fflush (stdin); |
| | printf (“Enter a value for Salary:\n”); |
| | scanf (“%f”,&Salary) |
| | return; |
| } | |
| // Function for input of Climate // | |
| void GetClimate (void) | |
| { | do |

| | |
|---|---|
| { | fflush (stdin); |

printf (“Enter a value for Climate:\n”);
printf (“Legal values are Hot, Mild, Cold.\n”);
gets (Climate)

| | }while (! (strcmp (Climate, “Hot”)) && ! (strcmp (Climate, “Mild”)) && |
|---|---|
| | ! (strcmp (Climate, “Cold”))); |
| | return; |
| } | |
| // Function for input of COLA // | |
| void GetCOLA (void) | |
| { | do |

| | |
|---|---|
| { | fflush (stdin); |

printf (“Enter a value for COLA:\n”);
printf (“Legal values are High, Medium, Low.\n”);
gets (COLA);

}while (! (strcmp (COLA, “High”)) && ! (strcmp (COLA, “Medium”)) &&
! (strcmp (COLA, “Low”)));
return;

}

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is described is a development environment that generates code that combines the actions of the inference engine and the knowledge of the expert, which is expressed in procedural rules in an if/then format, thereby eliminating the inference engine.

I claim:

1. An intelligent system software development system, comprising:
at least one database;
at least one Conditions table stored as part of the database, for storing at least one condition;
at least one Actions table stored as part of the database, for storing at least one action;
at least one Rule Structure table stored as part of the database, for storing at least one rule structure;
a Rule Builder, which allows the creation of at least one rule using at least one condition from the Conditions table and at least one Action from the Actions table in a manner corresponding to a record in the Rule Structure table;
a rule refinement system that simplifies and orders rules; and,
a code generator that generates code that is usable by procedural languages without the need for an inference engine.

2. A method of implementing an intelligent system which does not contain an inference engine, comprising:
determining the scope of a project by creating a knowledge map;
initializing the project by specifying at least a name and file information;
defining and verifying at least one condition and at least one action to be used in the project;
associating at least one condition with at least one action, thereby creating at least one legal rule cluster;
assigning at least one rule type to each rule cluster;
determining which rule clusters are deterministic;
creating at least one rule using combinations of the at least one rule cluster, at least one condition, and the at least one action;
verifying that the at least one rule meets applicable verification criteria;
simplifying the deterministic rule clusters;
making the simplified rule clusters available to other rule types;
ordering the rules by the rule type for the rule cluster;
generating code from the specifications into the desired language in a manner that eliminates the need for an inference engine.

3. The intelligent system implementation method of claim 2, wherein the simplifying step further allows for the optional simplification of other rule cluster types.

4. The intelligent system implementation method of claim 2, further including the step of defining at least one rule type for each rule cluster.

5. The intelligent system implementation method of claim 4, wherein the verifying step uses the at least one rule type to dictate the verification method used.

6. The intelligent system implementation method of claim 4, wherein the simplifying step uses the at least one rule type to dictate the simplification method used.

7. The intelligent system implementation method of claim 4, wherein the ordering step uses the at least one rule type to dictate the ordering method used.

8. The intelligent system implementation method of claim 4, wherein the verifying step uses the at least one rule type to dictate the verification method used, the simplifying step uses the at least one rule type to dictate the simplification method used, and the ordering step uses the at least one rule type to dictate the ordering method used.

9. The intelligent system implementation method of claim 4, wherein the ordering step uses the at least one rule type to determine a proper rule order.

10. The intelligent system implementation method of claim 9, wherein the use of the at least one rule type allows appropriate rules to be tested first in a first rule satisfied environment.

11. The intelligent system implementation method of claim 4, wherein verification criteria are applied in real-time while the at least one rule is created based on the rule type.

12. The intelligent system implementation method of claim 2, wherein the simplifying step uses verification criteria associated with the at least one rule to control the simplification process.

13. The intelligent system implementation method of claim 2, wherein the code generated during the generating step is code for a procedural computer programming language that can be executed without an inference engine.
